(19) United States
(12) Patent Application Publication
(10) Pub. No.: US 2016/0240081 A1
(43) Pub. Date: Aug. 18, 2016

(54) Geographic Based Location System Arranged For Providing, Via A Web-Based Portal, Management Information Of Geographic Data And Non-Geographic Data Generated By A Plurality Of Wireless Communication Devices, And A Related Method

(71) Applicant: DATA MINING INNOVATORS B.V., Wageningen (NL)

(72) Inventor: Michel Wissink, Wageningen (NL)

(73) Assignee: Data Mining Innovators B.V., Wageningen (NL)

(21) Appl. No.: 15/024,551

(22) PCT Filed: Sep. 24, 2013
(86) PCT No.: PCT/NL2013/050685

§ 371 Date: Mar. 24, 2016

(51) Int. Cl. G08G 1/13; H04L 29/08; H04L 12/26; H04W 64/00

(52) U.S. Cl. CPC G08G 1/13; H04W 64/006; H04L 67/12; H04L 43/10

(57) ABSTRACT

A geographic based location system, comprising a plurality of wireless communication devices, wherein each wireless communication device is arranged for obtaining geographic data and non-geographic data, and for communicating said geographic data and non-geographic data in frames over a wireless communication network, a storage database server arranged for receiving said geographic data and non-geographic data over said wireless communication network, and for storing said geographic and non-geographic data in a storage database, a presentation database server arranged for compressing said geographic and non- geographic data in said storage database to a presentation database, wherein said compressing of said geographic and said non-geographic data comprises compressing said geographic and said non- geographic data into segments of variable length, wherein a start of a segment is triggered by a change in said non-geographic data, and wherein data in said segments are stored incremental, a web-based user portal arranged for receiving a query out of a predefined list of available queries from a user, performing said query on said presentation database and for displaying results of said query to said user.

### BACKGROUND

American patent U.S. Pat. No. 7,701,363 discloses a vehicle monitoring and traffic enforcement system in which a wireless communication device is associated with motor vehicles. The device is arranged to transmit vehicle identification data which is relayed to a database which maintains current information concerning insurance law compliance, motor vehicle registration and licensing compliance, traffic citations and other information.

If a violation or compliance failure is noted, this is transmitted to a law enforcement agency and a nearby law enforcement vehicle. A law enforcement office may be required to pursue the vehicle depending on the violation and traffic conditions. The system uses Global Positioning System, GPS, technology to provide law enforcement with a real time display which will show the vehicle being tracked but also a map of the area showing roads, traffic conditions and the location of other law enforcement or emergency vehicles so that officials may make a safe and fast response to situations.

U.S. Patent application 2011/0246025 discloses a vehicle position tracking system comprising an in-vehicle device, and a centre device. The in-vehicle device comprises a GPS detector for detecting a vehicle position; and environmental information obtaining element for obtaining environmental information having detection data, a communicating element for communicating with the centre device, and a controller for controlling the communication element to transmit the environment information when reception of a GPS signal via the GPS detector is interrupted.

The centre device comprises a communication information obtaining element for obtaining the environmental information from the in-vehicle device, a database for obtaining observation information having observation data, and an estimation unit for estimating a moving route of the vehicle based on the environmental information such that the estimation unit arranges multiple observation position data corresponding to multiple retrieved observation data in a chronological order. The estimation unit retrieves multiple observation data corresponding to multiple detection data.

U.S. Pat. No. 6,246,938 discloses a vehicle provided with a GPS receiver coopering with a satellite positioning system in order to determine the position of the vehicle and subsequently to control, on the basis of the position detected, a distribution device, by adjusting the quantity of product distributed and its spreading methods as a function of the positions of the vehicle along a road route in order to adapt the spreading parameters to the morphological condition of the route.

The present invention is related to a geographic based location system arranged for providing an insight in geographic data and non-geographic data of multiple wireless communication devices.

A drawback of the vehicle tracking systems known in the art is that these systems are not able to provide real-time management information of wireless communication devices generating geographic data and non-geographic data in a quick manner.

Accordingly, it is an object of the present invention to provide for a geographic based location system which overcomes the above mentioned drawback.

### SUMMARY

In order to accomplish that object, the invention, according to a first aspect thereof, provides for a geographic based location system, comprising a plurality of wireless communication devices, wherein each wireless communication device is arranged for obtaining geographic data and non-geographic data, and for communicating said geographic data and non-geographic data in frames over a wireless communication network, a storage database server arranged for receiving said geographic data and non-geographic data over said wireless communication network, and for storing said geographic and non-geographic data in a storage database.

The geographic based location system further comprises a presentation database server arranged for compressing said geographic and non-geographic data in said storage database to a presentation database, wherein said compressing of said geographic and said non-geographic data comprises compressing said geographic and said non-geographic data into segments of variable length, wherein a start of a segment is triggered by a change in said non-geographic data, and wherein data in said segments are stored incremental, and a web-based user portal arranged for receiving a query out of a predefined list of available queries from a user, performing said query on said presentation database and for displaying results of said query to said user.

The invention is based on the perception that geographic and non-geographic data can be processed, displayed and/or stored in a quick manner in case these data are compressed into segments having variable length, wherein a start of a segment is triggered by a change in non-geographic data. The inventors noted that queries available to the user often have the intrinsic property that they relate to a change in non-geographic data, i.e. data corresponding to queries are usually delimited by the non-geographic data.

By compressing the geographic and non-geographic data into segments according to the invention, queries can be performed on the compressed data resulting in faster output to the user via the web-based portal.

A further speed enhancement is achieved by storing the data in the segments incremental, i.e. storing the data relative to each other in stead of storing the actual values of the data. The inventors have noted that less amount of data is required for storing the geographic and non-geographic data relative to each other, leading to speed improvements.

The storage database server is utilized as a fail safe server for retaining all data send by the wireless communication devices for at least a predefined time period. This insures that the data is always recoverable, even if the data in the presentation database gets corrupt somehow.

In an embodiment of the invention, the wireless communication devices are arranged to be installed in vehicles, wherein the geographic data are data representing a geographic location of a vehicle, and wherein the non-geographic data are data obtained from physical sensors installed in the vehicle.

An example of such a vehicle is a winter service vehicle, i.e. gritter arranged to spread grit, rock salt, onto roads. The grit is stored in a large hopper on the rear of the vehicle, with a wire mesh over the top to prevent foreign objects from entering the spreading mechanism and hence becoming jammed. The salt is generally spread across the roadway by an impeller, attached by a hydraulic drive system to a small onboard engine.

The wireless communication devices are not only arranged for obtaining geographic data, for example GPS coordinates, but also a variety of non-geographic data such as the status of the impeller, the width of the spreading of the salt, the amount of salt left in the large hopper, the quantity of salt which is being spread by the impeller, etc.

These data are sent, by the wireless communication devices in frames over a wireless communication network, such as the 3G network, the Global System for Mobile Communications network using for example General Packet Radio Service, GPRS, etc. These data are then received by and stored in a storage database for responsibility issues.

In order to improve the experienced speed for a user of the web-based portal, the inventors noted that the received information should be efficiently compressed such that the data can be processed efficiently. In order to do so, the received data are compressed in segments every time a change in the non-geographic data occurs. This leads to variable length segments, in which every segment comprises a variety of geographic data.

In another embodiment of the invention, each frame contains geographic data representing one geographic location, and wherein a subsequent frame is generated whenever a predefined time period has elapsed, i.e. 1 second, 2 seconds, or the like, and whenever said geographic location has altered with at least a predefined distance.

The advantage of the above mentioned embodiment is that the wireless communication network, over which the frames are communicated, is not unnecessarily occupied. The inventors noted that it is not necessary to continuously transmit all geographic data over the wireless communication network as a very accurate geographic location is assured in the system on second base.

The condition that a predefined time period needs to be elapsed is applied as otherwise too much data will be send over the wireless communication network, for example in case the vehicle is moving at a speed above 36 kilometers per hour. This leads to a significant reduction in costs, i.e. costs related to the data transfer over the network.

In another embodiment of the invention, the communication devices comprise storage means for temporarily locally storing the geographic data and non-geographic data for at least one day, preferably three days.

The above mentioned embodiment has the positive effect that additional redundancy is added to the system. The data is saved by the storage database server, which is utilized as a fail safe server for retaining the data send by the wireless communication devices, but the data is also stored locally, i.e. distributed, in every wireless communication device. For example, in every vehicle in which the wireless communication device is stored.

In yet another embodiment of the present invention, the presentation database server is arranged to pre-generate intermediate results of the predefined queries and to store these results in the presentation database.

The inventors noted that in order to improve the experienced speed by the end user, i.e. the user operating the web-based user portal, intermediate results can be pre-generated for at least a part of many of the available predefined queries. For example, those parts of the queries related to account settings of the user, list of wireless communication devices of the user, geographic interest of the user, etc., can be pre-generated by the presentation database server. This results in an improvement of speed as these intermediate results do not need to be generated real-time, i.e. whenever the user actually requests them.

In a further embodiment of the invention, the wireless communication devices are arranged for obtaining geographic data by at least one of a Global Positioning System, GPS, receiver, a base station trigonometry receiver and an accelerometer. A combination of a GPS receiver with an accelerometer has the positive effect that the actual location of the wireless communication device can be determined more accurately.

The inventors noted that the use of a GPS receiver is especially useful for determining long distance locations. To improve the accuracy of the actual location of the GPS receiver, the accelerometer is used to improve the location determined by the GPS receiver.

In another embodiment of the invention, the non-geographic data comprises at least one of user input, on/off status of spreading of de-icing product, width of spreading of de-icing product, time stamp, quantity of spreading of de-icing product, quantity of available de-icing product, etc.

In a second aspect, the invention provides for a method of visualizing geographic data and non-geographic data, the method comprising the steps of obtaining geographic data and non-geographic data by a wireless communication device, generating frames from the geographic data and non-geographic data and communicating the frames over a wireless communication network towards a storage database server, receiving the geographic data and non-geographic data and storing the geographic data and non-geographic data in a storage database, compressing the geographic data and non-geographic data in the storage database to a presentation database, wherein the compressing comprises compressing the geographic data and non-geographic data into segments of variable length, wherein a start of a segment is triggered by a change in the non-geographic data, and wherein data in the segments are stored incremental, receiving a query out of a predefined list of available queries from a user via a web-based user portal, performing the query on the presentation database and displaying results of the query to the user via the web-based user portal.

The data in the segments are stored incremental. This means that only changes in the data are stored. As long as the data is not changed, no data is stored in the presentation database.

In an embodiment of the invention, the method further comprises the step of temporarily locally storing the geographic and non-geographic data for at least one day, preferably three days, in storage means comprised in the communication devices.

In another embodiment of the invention, the method further comprises the step of further comprising pre-generating intermediate results of the predefined queries and storing the results in the presentation database as explained above.

The invention will now be explained in more detail with reference to the appended figures, which merely serve by way of illustration of the invention and which must not be construed as being limitative thereto.

### BRIEF DESCRIPTION OF THE DRAWINGS

FIG. 1 shows, in a schematic form, a part of a geographic based location system according to the present invention.

FIG. 2 shows, in a schematic form, a method of visualizing geographic data and non-geographic data via a web-based user portal, according to the present invention.

### DETAILED DESCRIPTION

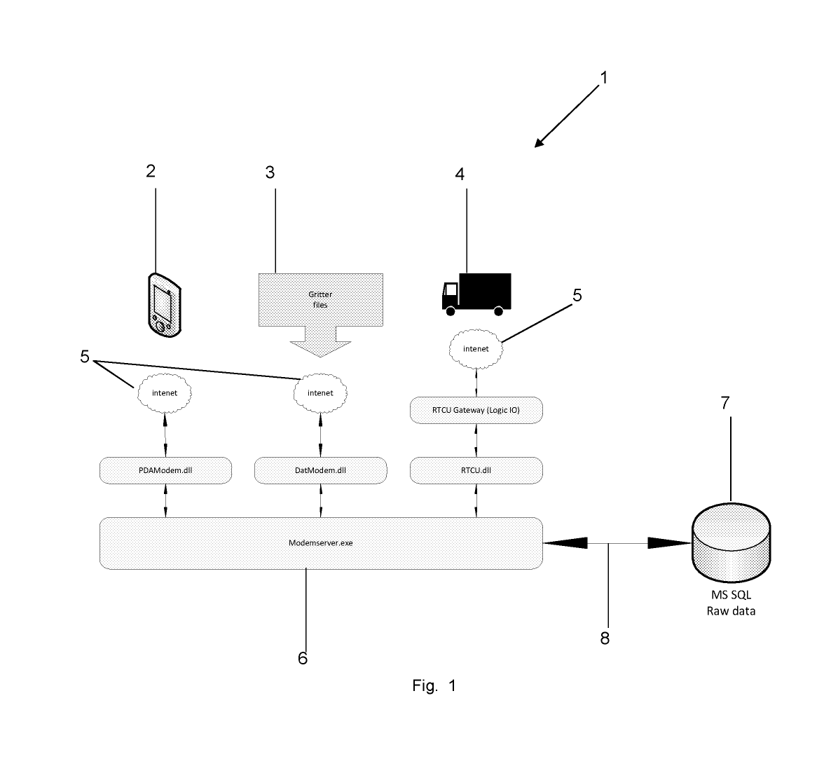

FIG. 1 shows, in a schematic form, a part 1 of a geographic based location system 1 according to the present invention.

The geographic based location system comprises a plurality of wireless communication devices 2, 3, 4, each of which is arranged for obtaining geographic data and non-geographic data. In an example, the mobile telephone 2 is arranged to transmit its GPS coordinates, along with remarks concerning the GPS coordinates over the internet 5 to a modem server 6. These remarks, i.e. non-geographic data, may comprise a variety of aspects, such as that a user detects litter and/or waste at the geographic coordinates, which should be removed.

In another example, gritter files 3 as well as GPS locations of the vehicle 4 are transmitted over the internet 5 to the modem server 6. Instead of over the internet 5, these data could be transmitted over a GSM connection, 4G connection, etc.

The data collected in the modem server 6 are, subsequently, transmitted 8 to a storage database server, i.e. an “Structured Query Language”, SQL raw database server 7. The SQL raw database server 7 is arranged to store the received geographic and non-geographic data in its database 7.

Further (not shown), a presentation database server is arranged for compressing the stored data into a presentation database, wherein the compressing of the geographic and the non-geographic data comprises compressing the data into segments of variable length, wherein a start of a segment is triggered by a change in the non-geographic data, and wherein data in the segments are stored incremental.

Data stored in the presentation database server is accessible by a web-based user portal, which is arranged for receiving a query out of a predefined list of available queries from a user, performing the query on the presentation database and for displaying the results of the query to the user.

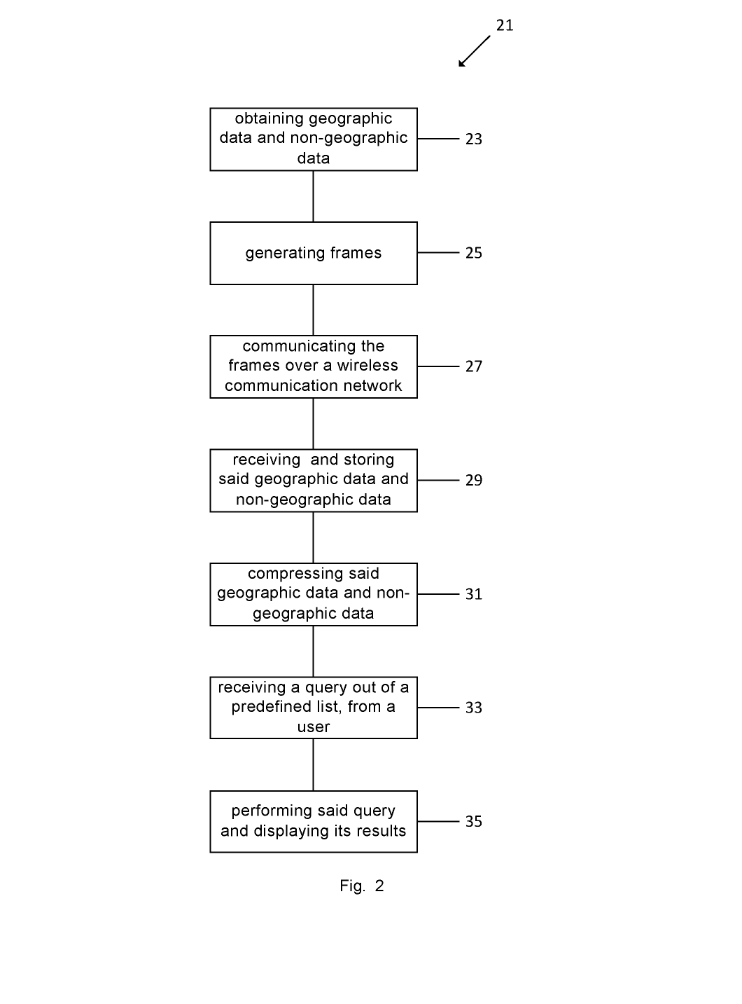

FIG. 2 shows, in a schematic form, a method 21 of visualizing geographic data and non-geographic data via a web-based user portal, according to the present invention.

First, geographic and non-geographic data is obtained 23 via a plurality of wireless communication devices, for example installed in a gritter or the like. The geographic data may be GPS coordinates, or any other type of location based data. Non-geographic data is, for example, data related to user input, on/off status of spreading of de-icing product, width of spreading of de-icing product, quantity of spreading of de-icing product and quantity of available de-icing product, etc.

In an example, the obtained geographic data comprises not only the actual geographic location, but also a time stamp at which the geographic location is obtained.

Next, frames are generated 25 based on the obtained data. These data are subsequently transmitted 27 in those frames over a wireless communication network such as the GSM network, wherein each frame comprises at least one geographic data, i.e. one geographic coordinate.

The storage data server is arranged to receive 29 the frames, and store the geographic data and non-geographic data in a storage database. Then, the data is compressed 32 into a presentation database server, wherein the step of compressing comprises compressing the geographic and the non-geographic data into segments of variable length, wherein a start of a segment is triggered by a change in the non-geographic data.

In a next step, a query is received 33 out of a predefined list of available queries from a user, by a web-based user portal, and the query is performed 35 on the data stored in the presentation database, and subsequently, its results are presented to the user via the web-based user portal.

The present invention has been explained in the foregoing by means of a number of examples. As those skilled in the art will appreciate, several modifications and additions can be realized without departing from the scope of the invention as defined in the appended claims.

1. A geographic based location system, comprising:
a plurality of wireless communication devices, wherein each wireless communication device is arranged for obtaining geographic data and non-geographic data, and for communicating said geographic data and non-geographic data in frames over a wireless communication network;
a storage database server arranged for receiving said geographic data and non-geographic data over said wireless communication network, and for storing said geographic and non-geographic data in a storage database;
a presentation database server arranged for compressing said geographic and non-geographic data from said storage database to a presentation database, wherein said compressing of said geographic and said non-geographic data comprises compressing said geographic and said non-geographic data into segments of variable length, wherein a start of a segment is triggered by a change in said non-geographic data, and wherein data in said segments are stored incremental;
a web-based user portal arranged for receiving a query out of a predefined list of available queries from a user, performing said query on said presentation database and for displaying results of said query to said user, wherein said wireless communication devices are arranged to be installed in vehicles, wherein said geographic data are data representing a geographic location of a vehicle, and wherein said non-geographic data are data obtained from physical sensors installed in said vehicle, and wherein said communication devices are arranged to generate frames, wherein each frame contains geographic data representing one geographic location, and wherein a subsequent frame is generated whenever a predefined time period has elapsed and whenever said geographic location has altered with at least a predefined distance.

2. (canceled)

3. (canceled)

4. The geographic based location system according to claim 1, wherein said communication devices comprise storage means for temporarily locally storing said geographic data and non-geographic data for at least one day.

5. The geographic based location system according to claim 1, wherein said presentation database server is arranged to pre-generate intermediate results of said predefined queries and to store these results in said presentation database.

6. The geographic based location system according to claim 1, wherein each wireless communication device is arranged for obtaining geographic data by at least one of a Global Positioning System, GPS, receiver, a base station trigonometry receiver and an accelerometer.

7. The geographic based location system according to claim 1, wherein said non-geographic data comprises at least one of:
user input;
on/off status of spreading of de-icing product;
width of spreading of de-icing product;
time stamp;
quantity of spreading of de-icing product;
quantity of available de-icing product.

8. A method of visualizing geographic data and non-geographic data, said method comprising the steps of:
obtaining geographic data and non-geographic data by a wireless communication device;
generating frames from said geographic data and non-geographic data and communicating said frames over a wireless communication network towards a storage database server;
receiving said geographic data and non-geographic data and storing said geographic data and non-geographic data in a storage database;
compressing said geographic data and non-geographic data in said storage database to a presentation database, wherein said compressing comprises compressing said geographic data and non-geographic data into segments of variable length, wherein a start of a segment is triggered by a change in said non-geographic data, and wherein data in said segments are stored incremental;
receiving a query out of a predefined list of available queries from a user via a web-based user portal,
performing said query on said presentation database and displaying results of said query to said user via said web-based user portal, wherein said geographic data are data representing a geographic location of a vehicle, and wherein said non-geographic data are data obtain from physical sensors installed in said vehicle, wherein each frame contains geographic data representing one geographic location, and wherein a subsequent frame is generated whenever a predefined time period has elapsed and whenever said geographic location has altered with at least a predefined distance.

9. (canceled)

10. (canceled)

11. The method according to claim 8, further comprising the step of temporarily locally storing said geographic and non-geographic data for at least one day, preferably three days, in storage means comprised in said communication devices.

12. The method according to claim 8, further comprising pre-generating intermediate results of said predefined queries and storing said results in said presentation database.

13. The method according to claim 8, wherein said step of obtaining geographic data and non-geographic data by a wireless communication device comprises obtaining geographic data by at least one of a Global Positioning System, GPS, receiver, a base station trigonometry receiver and an accelerometer.

14. The method according to claim 8, wherein said non-geographic data comprises at least one of:
user input;
on/off status of spreading of de-icing product;
width of spreading of de-icing product;
quantity of spreading of de-icing product;
quantity of available de-icing product;
type of de-icing product.

15. The geographic based location system according to claim 4, wherein said communication devices comprise storage means for temporarily locally storing said geographic data and non-geographic data for at least three days.
